(19) United States
(12) Patent Application Publication
(10) Pub. No.: US 2017/0257369 A1
(43) Pub. Date: Sep. 7, 2017

(54) FLEXIBLE FEATURE ENABLING INTEGRATED CIRCUIT AND METHODS TO OPERATE THE INTEGRATED CIRCUIT

(71) Applicant: Altera Corporation, San Jose, CA (US)

(72) Inventor: Ken A. Ito, San Jose, CA (US)

(21) Appl. No.: 15/061,790

(22) Filed: Mar. 4, 2016

(51) Int. Cl. H04L 29/06; G06F 21/10

(52) U.S. Cl. CPC H04L 63/0876; G06F 21/105; H04L 63/061; H04L 63/045

(57) ABSTRACT

A method for enabling a circuit feature on an integrated circuit device having inactive circuit features includes a step to receive an encrypted message and a signed digital signature from a server using an input/output (I/O) terminal within the integrated circuit device. The method also includes a step to decrypt the encrypted message using a public key to obtain a decrypted message using a data decryption block within the integrated circuit device. Furthermore, the method also includes a step to enable one of the inactive circuit features on the integrated circuit device that corresponds to the decrypted message after decrypting the encrypted message. The method may be performed by a flexible feature enabling integrated circuit.

### BACKGROUND

Slow moving inventory (SMI) is an issue that is not desired by retailers and manufacturers. However, retailers and manufacturers have deemed this issue to be a persistent and inevitable problem in running a commercial activity. Furthermore, this issue becomes a bigger problem (at least in terms of manufacturing cost) when industries related to manufacturing integrated circuit devices are involved, specifically large and specialized devices such as microprocessor and field programmable gate arrays.

One of identified causes of the SMI issue in the industry related to manufacturing the integrated circuit devices may be inflexibility in terms of selling the devices as each of the device are tied to a particular set of circuit features and further identified by way of a particular part number. Hence, if the industry is consuming only specific feature type devices for a period of time, the remaining feature types of devices are stored in inventory and may eventually deemed as SMI. This could result because these devices may be tied to a particular set of circuit features and are identified by a particular part number and hence are restricted when being sold to the customers

Generally the SMI issue is resolved by careful planning by the manufacturing house. However, even with excellent planning by the manufacturing house, this problem can remain because of constant changes in market which are often difficult to predict.

### SUMMARY

Embodiments described herein include a flexible feature encrypted integrated circuit and methods of operating the integrated circuit. It should be appreciated that the embodiments can be implemented in numerous ways, such as a process, an apparatus, a system, a device, or a method. Several embodiments are described below.

In one embodiment, a method for enabling a circuit feature on an integrated circuit device having circuit features, which are inactive, includes a step to receive an encrypted message and a signed digital signature from a server using an input/output (I/O) terminal within the integrated circuit device. The method also includes a step to decrypt the encrypted message using a public key to obtain a decrypted message using a data decryption block within the integrated circuit device. Furthermore, the method also includes a step to enable one of the circuit features on the integrated circuit device that corresponds to the decrypted message after decrypting the encrypted message.

In another embodiment, a method for enabling a circuit feature on an integrated circuit device using a manufacturing server includes a step to receive a license file and a public key of the integrated circuit device. The license file includes the circuit feature that is requested to be enabled. The method further includes a step to determine whether the circuit feature is capable of being enabled on the integrated circuit device. Furthermore, the method also includes a step of generating an encrypted message and a signed digital signature when the circuit feature is determined as capable of being enabled. The encrypted message may include a message to enable the circuit feature. Finally, the method also includes a step to transmit the encrypted message and the signed digital signature to the integrated circuit device.

In an alternative embodiment, an integrated circuit device includes a first circuit feature and a second circuit feature. The first circuit feature is formed within the integrated circuit device and is enabled for a user's use. The second circuit feature is also formed within the integrated circuit device and but only available to the user when the second circuit feature is enabled through an enabling message that is received from external source. The integrated circuit device decrypts and authenticates the enabling message prior to enabling the second circuit feature.

Further features of the invention, its nature and various advantages will be more apparent from the accompanying drawings and the following detailed description of the preferred embodiments.

### BRIEF DESCRIPTION OF THE DRAWINGS

FIG. 1 shows an illustrative system to enable a circuit feature on an integrated circuit device in accordance to one embodiment of the present invention

FIG. 2 shows illustrative circuitry for enabling a feature in accordance to one embodiment of the present invention.

FIG. 3 shows a flowchart of an illustrative method of enabling an inactive circuit feature on an integrated circuit device in accordance with an embodiment of the present invention.

FIG. 4 shows a flowchart of an illustrative method of enabling a circuit feature on an integrated circuit device by a server in accordance to one embodiment of the present invention.

### DETAILED DESCRIPTION

The following embodiments include a flexible feature encrypted integrated circuit and methods of operating the integrated circuit. It will be obvious, to one skilled in the art, that the present exemplary embodiments may be practiced without some or all of these specific details. In other instances, well-known operations have not been described in detail in order not to unnecessarily obscure the present embodiments.

Throughout this specification, when an element is referred to as being “connected” or “coupled” to another element, it may be directly connected or coupled to the other element or electrically connected or coupled to the other element with yet another element interposed between them.

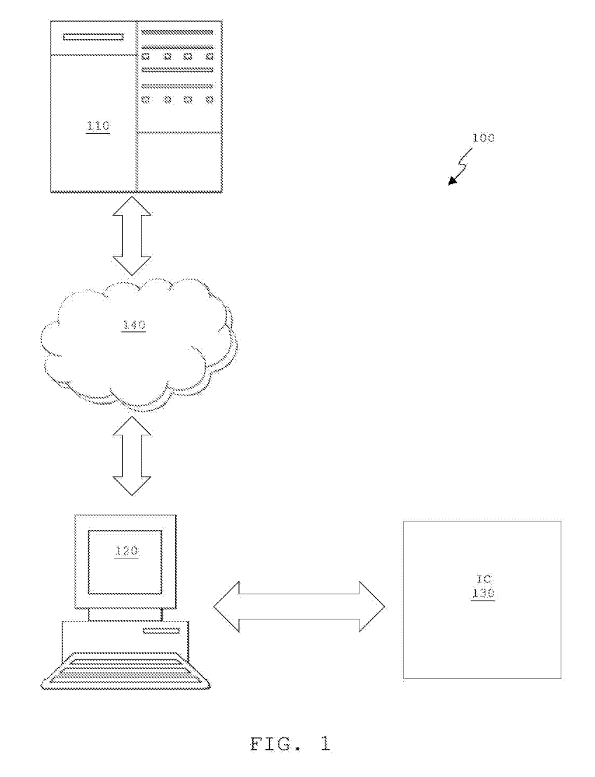

FIG. 1, meant to be illustrative and not limiting, illustrates a system to enable a circuit feature on an integrated circuit device in accordance to one embodiment of the present invention. System 100 includes server 110, remote computer 120 and integrated circuit device 130. In the embodiment of FIG. 1, integrated circuit device 130 may include circuit features that are enabled and ready to be utilized by a user of device 130. In addition, integrated circuit device 130 may also include additional circuit features that may not be enabled. These additional circuit features are not available to the user unless these additional circuit features are first enabled.

System 100 provides a means to a user or a buyer of integrated circuit device 130 to enable the additional circuit features. The additional circuit features on integrated circuit device 130 may be a circuit block such as transceiver (XVCR) circuits, phase-locked loop (PLL) circuits, memory circuits, processing circuits, voltage controller oscillator (VCO) circuits, and/or analog-to-digital converter (ADC) circuits in one embodiment. In another embodiment, the additional circuit features on integrated circuit device 130 may be circuit features that are available for a circuit block (e.g., a XCVR circuit, a PLL circuit, a memory circuit, a processing circuit, a VCO circuit and/or an ADC circuit). In general, the additional circuit features may include any desired circuit blocks, circuit components, circuit features, or combinations of these that are not initially enabled on device 130. System 100 may enable these additional circuit features upon a request from the user. In one embodiment, the request may be at a much later date then the date when integrated circuit device 130 was purchased by the user. However, the integrated circuit device 130 may, if desired, be purchased by an entity other than the user. Furthermore, system 100 provides a means to enable these additional circuit features from a location that may be relatively far away from (e.g., remote to) the manufacturing facility that manufactured the integrated circuit device 130.

It should be appreciated that system 100 shown in the embodiment of FIG. 1 is a simplified depiction of a system that enables the additional circuit features on integrated circuit device 130. System 100 may be coupled to many more users (e.g., remote computers 120), who could request to enable the additional circuit features in their respective integrated circuit devices (e.g., integrated circuit device 130). Each of these users may be coupled to server 110 through communications network 140, in one embodiment.

Referring still to FIG. 1, server 110 may be a computer server. Server 110 may be provided by a seller/vendor of integrated circuit device 130. It should be appreciated that a server is generally referred to a computing device or an apparatus that is running a computer program. However, the computer program that is capable of responding to requests from clients (e.g., remote computer 120) may also be referred to as the server.

In the embodiment of FIG. 1, server 110 may be located at a manufacturing plant of device 130. Hence, server 110 may also be referred as a manufacturing server. Alternatively, server 110 may be located at a premises that is owned by the seller of integrated circuit device 130. As shown in the embodiment of FIG. 1, server 110 may be coupled to at least one remote computer 120 through communications network 140 (e.g., the internet, an isolated local area network (LAN), a virtual private network (VPN) to which at least one remote computer 120 is connected, etc.). It should be appreciated that forming network 140 as a VPN may increase the security for system 100 relative to scenarios where unsecured networks are used.

Alternatively, a server (e.g., server 110) may be directly coupled to a computer (e.g., remote computer 120) without a network 140. In such an embodiment, server 110 may be coupled to remote computer 120 through a cable or other direct connection. However, the remote computer may have to be at/near a location that includes server 110 in this arrangement. When the remote computer is coupled to the server through the cable, the remote computer may be communicating with the server through a peripheral component interconnect express (PCIe) transmission protocol standard or other bidirectional serial standards (e.g., RS232 or RS485 standards).

Server 110 determines whether a circuit feature on integrated circuit device 130 that a user requests is allowed to be enabled. In one embodiment, server 110 may be executing a computer program that performs this determination. Generally, a computer program may include instructions to direct a computer to perform specific operations. In addition, the computer program may include libraries and related non-executable data.

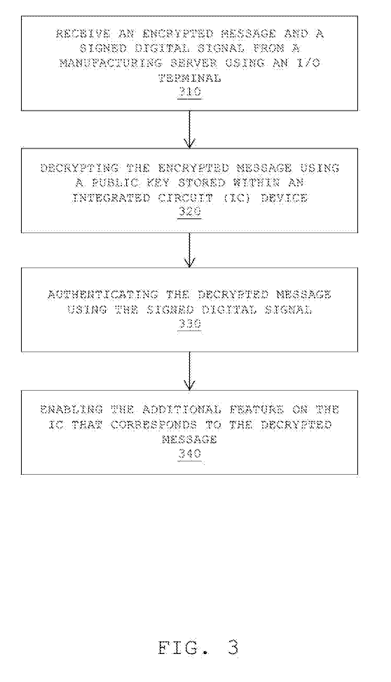

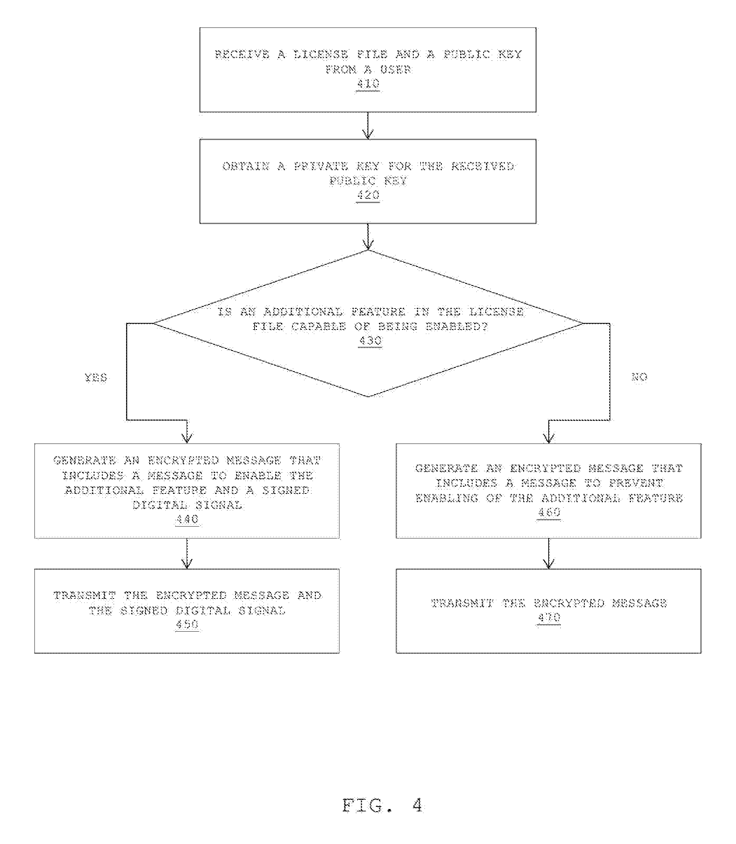

In one embodiment, the computer program executed by server 110 may include steps such as: (a) determining whether a circuit feature that a user using remote computer 120 requests is allowed to be enabled, and (b) generating an appropriate message once the determination is complete. Each of these steps may include sub-steps, which are provided in detail through flowcharts illustrated in FIGS. 3 and 4.

The appropriate message that is generated by server 110 may be transmitted to remote computer 120 through network 140. In one embodiment, remote computer 120 may be a computer, which is a general-purpose device that can be programmed to carry out a set of arithmetic or logical operations automatically. Remote computer 120 may include a central processing unit (CPU), memories and other peripheral devices (e.g., keyboard, mouse, etc.). Similar to server 110, remote computer 120 may execute a computer program. In one embodiment, the computer program that remote computer 120 may execute is a configuration tool. The configuration tool may be Quartus II from Altera Corporation, Vivado from Xilinx Corporation, etc., in one exemplary embodiment. It should be appreciated that the configuration tool may be stored within a hard disk of remote computer 120 and is executed based on the user's directions.

The inputs for remote computer 120 may be received from a user. In one embodiment, the user may direct remote computer 120 to enable an additional circuit feature. The process of enabling the additional circuit features by a user using remote computer 120 may include steps such as: (i) the user entering the additional circuit features that are to be enabled into a license file, (ii) obtaining a public key that is stored within integrated circuit device 130, (iii) transmitting the license file and the public key to server 110, (iv) receiving an appropriate message from server 110, and (v) forwarding the appropriate message to integrated circuit device 130. The additional circuit features that are entered into the license file may be selected from the group of circuits that are not yet enabled (e.g., the transceiver circuit blocks, PLL circuit blocks and memory circuit blocks).

As shown in the embodiment of FIG. 1, remote computer 120 is coupled to integrated circuit device 130. Remote computer 120 may communicate with integrated circuit device 130 through a standard protocol (e.g., joint test action group (JTAG) communication protocol). However, it should be appreciated that other appropriate standard signal transmission protocols may also be utilized for signal communications between remote computer 120 and integrated circuit device 130.

Integrated circuit device 130 may be an application specific integrated circuit (ASIC) device, an application standard specific product (ASSP) device, a programmable logic device (PLD) or a microprocessor device. In general, the ASIC and ASSP devices may perform fixed and dedicated functions. The PLD devices may be programmable to perform a variety of functions. An example of a PLD device may be a field programmable gate array (FPGA) device. Microprocessor devices, coupled together with other devices (e.g., a memory device), may be utilized to perform instructions provided within a programming code.

Integrated circuit device 130 may be used in different types of high speed systems, for example a communication system such as wireless systems, wired systems, etc. In one embodiment, integrated circuit device 100 may be a PLD that is utilized for controlling data transfer between different devices, for example, a microprocessor device and a memory device. Hence, integrated circuit device 130 may include circuits that may be used to implement various transmission standards that allow integrated circuit device 130 to communicate with external devices such as memory devices (not shown) that may be coupled to integrated circuit device 130. In one exemplary embodiment, integrated circuit device 130 may include a JTAG interface to receive inputs from remote computer 120.

As stated above, integrated circuit device 130 may include circuit features that are already enabled and additional circuit features that may require enabling before being available to the user. Integrated circuit device 130, upon receiving the appropriate message that is forwarded from remote computer 120, may decrypt the appropriate message and verify the signature. Once the appropriate message has been decrypted and authenticated, integrated circuit device may either: (a) enable an additional circuit feature, or (b) disregard and not enable any additional circuit feature.

In one embodiment, integrated circuit device 130 may include circuit features such as logic circuitry, input/output circuits, transceiver circuit blocks, phase-locked loop circuit blocks and memory circuit blocks. As stated above, a portion of these circuit features may be enabled and another portion of these circuit features may not be enabled. In addition, integrated circuit device 130 may also include a public key. The public key is generally utilized in the public-key cryptography. In one embodiment, the public key may be embedded in integrated circuit device 130 as a sequence of blown fuses and/or antifuses.

Logic circuitry may be utilized for performing core functions of integrated circuit device 130. The logic circuitry may include specific circuitry for the functions that defines integrated circuit device 130. For example, the logic circuitry may include circuits that perform memory device addressing and processing of information retrieved from the memory device when integrated circuit device 130 is used as a memory controller. In another example, the logic circuitry may include programmable logic elements when integrated circuit is a PLD. The programmable logic elements may further include circuits such as look-up table circuitry, multiplexers, product-term logic, registers, memory circuits and the like. The programmable logic elements may be programmed by a user (e.g., a designer or an engineer) to perform desired functions.

The I/O circuits and transceiver circuit blocks may be utilized for transferring signals in or out of integrated circuit device 130. For example, a signal from the logic circuitry may be transferred out of integrated circuit device 130 through one of the I/O circuits or transceiver circuit blocks. Additionally, a signal received from an external device (e.g., remote computer 120) may be transferred to the logic circuitry through one of the I/O circuits or transceiver circuit blocks. In one embodiment, the I/O circuits and transceiver circuit blocks may be considered as external interfacing circuitry of integrated circuit device 130.

Each PLL circuit block within integrated circuit device 130 may help to generate an output signal whose phase is related to the phase of an input signal. The PLL circuit block may be utilized to generate a clock signal that has an identical phase to a reference clock signal. Memory circuit blocks within integrated circuit device 130 may be utilized as storage elements. In one embodiment, memory blocks may include multiple static random access memory (SRAM) elements. Alternatively, memory blocks may include multiple dynamic random access memory (DRAM) elements.

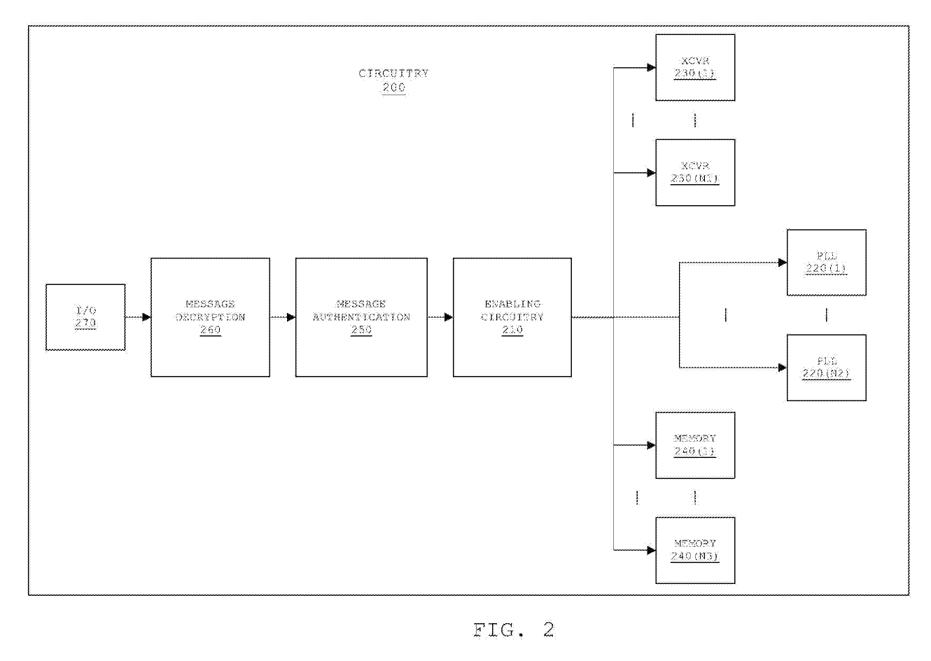

FIG. 2, meant to be illustrative and not limiting, illustrates circuitry for enabling a circuit feature in accordance to one embodiment of the present invention. In one embodiment, circuitry 200 may be formed within integrated circuit device 130 of FIG. 1.

Circuitry 200 includes input/output (I/O) circuit 270, transceiver (XVCR) circuit blocks 230(1)-230(N1) and phase-locked loop (PLL) circuit blocks 220(1)-220(N2), memory circuit blocks 240(1)-240(N3), enabling circuitry 210, message decryption block 260 and message authenticator block 250. In one embodiment, the values for N1, N2 and N3 may be different. For example, the value for N1 may be more than 20, the value for N2 may be more than 4 and the value for N3 may be more than 4. Alternatively, the values for N1, N2 and N3 may be identical. For example, the values of N1, N2 and N3 may be 4 or more. It should be appreciated that circuitry 200 may include other circuits that are not shown in embodiment of FIG. 2, for example, digital signal processor (DSP) circuits, voltage controlled oscillators (VCO), processing circuits, etc.

Although circuitry 200 includes the abovementioned circuits, only a portion of the abovementioned circuits are enabled when purchased. The remaining circuits may not yet be enabled. In an exemplary embodiment, only transceiver circuit block 230(1), PLL circuit block 220(1) and memory circuit block 240(1) are enabled within circuitry 200 when an integrated circuit device is purchased, whereas transceiver circuit blocks 230(2)-230(N1), PLL circuit blocks 220(2)-220(N2) and memory circuit blocks 240(2)-240(N3) are not yet enabled. In another exemplary embodiment, only transceiver circuit blocks 230(1) and 230(2), PLL circuit blocks 220(1) and 220(2) and memory circuit blocks 240(1) and 240(1) are enabled within circuitry 200, whereas transceiver circuit blocks 230(3)-230(N1), PLL circuit blocks 220(3)-220(N2) and memory circuit blocks 240(3)-240(N3) are not yet enabled.

Each of the not-yet-enabled circuits (e.g., a portion of transceiver circuit blocks 230(1)-230(N1), PLL circuit blocks 220(1)-220(N2) and memory circuit blocks 240(1)-240(N3)) are coupled to enabling circuitry 210. In one embodiment, enabling circuitry 210 may include fuses. Each fuse within enabling circuitry 210 may be tied to at least one not-yet-enabled circuit. For example, within enabling circuitry 210, a first fuse may be tied to transceiver circuit block 230(1), a second fuse may be tied to PLL circuit block 220(1) and a third fuse may be tied to memory circuit block 240(1). Each of these not-yet-enabled circuits may be enabled when their respective fuse within enabling circuitry 210 is blown. For example, transceiver circuit block 230(1) may be enabled when the first fuse is blown, PLL circuit block 220(1) may be enabled when the second fuse is blown and memory circuit block 240(1) may be enabled when the third fuse is blown. In one embodiment, the fuse may be similar to a polysilicon fuse structure.

In an alternative embodiment, enabling circuitry 210 may include antifuses. Unlike fuses, which are low resistance paths and may form electrical open connections when being blown, antifuses are high resistance paths and forms electrical shorted connections when blown. However, similar to the fuses, each antifuse within enabling circuitry 210 may be tied to one at least one not-yet-enabled additional circuit feature. These not-yet-enabled additional circuit features may be enabled when their respective antifuse within enabling circuitry 210 is blown.

In another embodiment, enabling circuitry 210 may include fuses/antifuses and a combination of fuses/antifuses may be tied to one not-yet-enabled circuit. Hence, in this embodiment, a combination or sequence of blown fuses/antifuses may be utilized to enable the not-yet-enabled additional circuit feature.

As shown in the embodiment of FIG. 2, enabling circuitry 210 may be coupled to message authenticator block 250, which is further coupled to message decryption block 260. As described in FIG. 1, an appropriate message forwarded by a remote computer (e.g., remote computer 120 of FIG. 1) may be received by circuitry 200 through I/O circuit 270. The appropriate message may be generated by a server (e.g., server 110 of FIG. 1). In one embodiment, the appropriate message may be encrypted using a private key. The private key, on the server, may correspond to the public key stored within circuitry 200.

The appropriate message may then be transmitted to message decryption block 260. Message decryption block 260 may decrypt the appropriate message using the public key stored in within the integrated circuit device having circuitry 200. In one embodiment, the public key may be formed when the integrated circuit device having circuitry 200 was manufactured. The public key may be a sequence of blown fuses, in one embodiment. Alternatively, the public key may be stored in a non-volatile memory as a binary sequence within the integrated circuit device.

In one embodiment, encrypting a message using a private key and decrypting the message using a public key is generally referred to as “public-key cryptography.” It should be appreciated that the public-key cryptography is often used to secure electronic communication over an open networked environment such as the Internet, without relying on a covert channel for key exchange. Open networked environments are susceptible to a variety of communication security problems such as man-in-the-middle attacks and other security threats.

In one embodiment, the message decrypted by message decryption block 260 may include: (i) instructions to enable at least one additional circuit feature (e.g., a portion of transceiver circuit blocks 230(1)-230(N1), PLL circuit blocks 220(1)-220(N2) and memory circuit blocks 240(1)-240(N3)), or (ii) instructions to not enable the additional circuit features. If the message includes instructions to not enable the additional circuit features of circuitry 200, then no further action is performed. However, if the decrypted message includes instructions to enable at least one additional circuit feature, the message may be forwarded to message authenticator block 250.

Message authenticator block 250 authenticates the received message using a signed digital signal that was also received from a server (e.g., server 110 of FIG. 1), in one embodiment. It should be appreciated that a digital signature may be a form of mathematical scheme that helps to authenticate a message. A valid signed digital signature allows circuitry 200 to confirm that the message was created by an authenticated sender (e.g., server 110 of FIG. 1), that the sender sent the message (authentication and non-repudiation), and that the message was not altered during the transmission.

Once message authenticator block 250 completes authenticating the message, the message may be transmitted to enabling circuitry 210. Once the message is received by enabling circuitry 210, the appropriate fuses/antifuses are blown. Based on that, the portion of addition circuit features that are to be enabled may become enabled. Once enabled, a user may use these enabled circuit features. By enabling the circuitry using fuses and antifuses, the enablement of circuit components based on the received message may be permanent (e.g., the blown fuses and antifuses may be irreversible).

FIG. 3, meant to be illustrative and not limiting, illustrates a flowchart of a method of enabling an inactive circuit feature on an integrated circuit device. In one embodiment, the integrated circuit device may be similar to integrated circuit device 130 of FIG. 1 or an integrated circuit device having circuitry 200 of FIG. 2. The integrated circuit device may be a part of a system that allows enabling inactive circuit features. In one exemplary embodiment, the system may be similar to system 100 of FIG. 1. The inactive circuit features may be similar to transceiver circuit blocks 230(1)-230(N1), PLL circuit blocks 220(1)-220(N2) or memory circuit blocks 240(1)-240(N3) of FIG. 2.

At step 310, integrated circuit device may receive an encrypted message and a signed digital signal from a server. The encrypted message and the signed digital signal may be received through an I/O circuit (e.g., I/O circuit 210 of FIG. 2). The server may be similar to server 110 of FIG. 1. The encrypted message may be forwarded to the integrated circuit device through a remote computer. In one exemplary embodiment, the integrated circuit device may be coupled to the remote computer through a standard signal transmission protocol (e.g., a JTAG signal transmission protocol).

At step 320, the encrypted message may be decrypted using a public key that is stored in the integrated circuit device. The decryption may be performed in a message decryption block (e.g., message decryption block 260), which forms part of the integrated circuit device. The public key may be embedded within the integrated circuit device (e.g., in a non-volatile memory or a sequence of blown fuses). In one embodiment, the decrypted message may include instructions to: enable an additional circuit feature (e.g., portions of transceiver circuit blocks 230(1)-230(N1), PLL circuit blocks 220(1)-220(N2) or memory circuit blocks 240(1)-240(N3) of FIG. 2), or (ii) not enable the additional circuit feature. If the message includes instructions to not enable the additional circuit feature on circuitry 200, then no further steps are performed.

At step 330, the decrypted message may be authenticated using a signed digital signal. In one embodiment, the authentication may be performed by a message authenticator block (e.g., message authenticating block 250 of FIG. 2) within the integrated circuit device.

If the decrypted message is an authentic message, the method proceeds to step 340. At step 340, the additional circuit feature that is within the decrypted message may be enabled. In one embodiment, the additional circuit feature may be enabled through enabling circuitry (e.g., enabling circuitry 210 of FIG. 2). Enabling circuitry may include fuses/antifuses that are tied to a particular additional circuit features. Upon request to enable that particular additional circuit feature, the fuse/antifuse may be blown. Once blown, the particular additional circuit feature may be enabled.

FIG. 4, meant to be illustrative and not limiting, illustrates a flowchart of a method of enabling a circuit feature on an integrated circuit device by a server in accordance to one embodiment of the present invention. The circuit feature may be similar to transceiver circuit blocks 230(1)-230(N1), PLL circuit blocks 220(1)-220(N2) or memory circuit blocks 240(1)-240(N3) of FIG. 2, and the server may be similar to server 110 of FIG. 1. In one embodiment, the method may be performed through a system similar to system 100 of FIG. 1.

At step 410, the server may receive a license file and a public key. The license file and the public key may be transmitted to the server by a remote computer similar to remote computer 120 of FIG. 1. The public key may be similar to the public key store in an integrated circuit device. In one embodiment, the license file and the public key may be transmitted through the internet (e.g., internet 140 of FIG. 1). Alternatively, the license file and the public key may be transmitted through a cable to the server. However, if the license file and the public key are transmitted through the cable, the remote computer that transmits them has to be within proximity of the server.

In one embodiment, the license file may include the circuit features that the user is requesting to be enabled. In one embodiment, the circuit features may be one or more of the selected circuit features from transceivers, PLLs and memory circuits.

At step 420, the server may obtain a private key that corresponds to the public key. It should be appreciated that the private key may be specific to the public key. Furthermore, the private key is stored within a secure network, to which the user has no access.

At step 430, the server makes a determination whether the circuit features are capable of being enabled. In one embodiment, the determination that is performed by the server may include a step to check whether the user has paid for the circuit features that the user intends to enable. This system is similar to the pay-to-use system. In addition, the determination that is performed by the server may also include a step to check whether a license limit of the circuit features for the integrated circuit device has been exceeded. Generally, the user may buy multiple circuit feature licenses. Each time the user intends to enable a circuit feature, the user may utilize one of its licenses on that circuit feature.

If the server determines that the circuit feature is capable of being enabled, then the method proceeds to step 440. In one exemplary embodiment, the method proceeds to step 440 when a computer program executed in the server determines that: (a) the user has paid for each circuit feature that the user intends to enable, and (b) each circuit feature requested is still within the license limit specific to that circuit feature and that user. However, if the server determines that the circuit feature is not capable of being enabled, then the method proceeds to step 460.

At step 440, an encrypted message that includes a message to enable the circuit feature is generated. In addition, a digital signed signal is also generated. In one embodiment, the encrypted message may be encrypted using the private key that corresponds to the public key.

At step 450, the encrypted message and the digital signed signal are transmitted out of the server. In one embodiment, the encrypted message and the digital signal may be transmitted to a remote computer (e.g., remote computer 120 of FIG. 1) and be forwarded to an integrated circuit device (e.g., integrated circuit device 130 of FIG. 1)

Alternatively, at step 460, an encrypted message that includes a message to not enable the circuit feature is generated. The message may prevent enabling the circuit feature that the user requested in its license file. The encryption may be performed using the private key too.

At step 470, the encrypted message may be transmitted from the server.

The embodiments thus far have been described with respect to integrated circuits. The methods and apparatuses described herein may be incorporated into any suitable circuit. For example, they may be incorporated into numerous types of devices such as programmable logic devices, application specific standard products (ASSPs), and application specific integrated circuits (ASICs). Examples of programmable logic devices include programmable arrays logic (PALs), programmable logic arrays (PLAs), field programmable logic arrays (FPGAs), electrically programmable logic devices (EPLDs), electrically erasable programmable logic devices (EEPLDs), logic cell arrays (LCAs), complex programmable logic devices (CPLDs), and field programmable gate arrays (FPGAs), just to name a few.

The programmable logic device described in one or more embodiments herein may be part of a data processing system that includes one or more of the following components: a processor; memory; IO circuitry; and peripheral devices. The data processing can be used in a wide variety of applications, such as computer networking, data networking, instrumentation, video processing, digital signal processing, or any suitable other application where the advantage of using programmable or re-programmable logic is desirable. The programmable logic device can be used to perform a variety of different logic functions. For example, the programmable logic device can be configured as a processor or controller that works in cooperation with a system processor. The programmable logic device may also be used as an arbiter for arbitrating access to a shared resource in the data processing system. In yet another example, the programmable logic device can be configured as an interface between a processor and one of the other components in the system. In one embodiment, the programmable logic device may be one of the families of devices owned by ALTERA Corporation.

Although the methods of operations were described in a specific order, it should be understood that other operations may be performed in between described operations, described operations may be adjusted so that they occur at slightly different times or described operations may be distributed in a system which allows occurrence of the processing operations at various intervals associated with the processing, as long as the processing of the overlay operations are performed in a desired way.

Although the foregoing invention has been described in some detail for the purposes of clarity, it will be apparent that certain changes and modifications can be practiced within the scope of the appended claims. Accordingly, the present embodiments are to be considered as illustrative and not restrictive, and the invention is not to be limited to the details given herein, but may be modified within the scope and equivalents of the appended claims.

What is claimed is:

1. A method for enabling a circuit feature on an integrated circuit device having inactive circuit features, the method comprising:
receiving, at an input/output (I/O) terminal on the integrated circuit device, an encrypted message and a signed digital signature from a server;
decrypting, at a data decryption block on the integrated circuit device, the encrypted message using a public key to obtain a decrypted message, wherein the decrypted message identifies an inactive circuit feature of the integrated circuit device; and
after decrypting the encrypted message, enabling the inactive circuit feature identified by the decrypted message on the integrated circuit device.

2. The method as defined in claim 1, wherein enabling the inactive circuit feature comprises:
blowing at least one fuse on the integrated circuit device that corresponds to the inactive circuit feature identified by the decrypted message.

3. The method as defined in claim 1, further comprising:
transmitting, at the I/O terminal, the public key to the server.

4. The method as defined in claim 1, further comprising:
authenticating, at a message authenticator block on the integrated circuit device, the encrypted message using the signed digital signature received from the server.

5. The method as defined in claim 1, further comprising:
receiving, at the I/O terminal, an error signal from the server when one of the inactive circuit features on the integrated circuit device is prevented from being enabled.

6. The method as defined in claim 1, wherein the integrated circuit device receives the encrypted message and the signed digital signature using a joint test action group (JTAG) transmission protocol.

7. The method as defined in claim 1, wherein the inactive circuit feature that is enabled comprises a circuit feature selected from the group of circuit features consisting of: phase-locked loop (PLL) circuits, memory circuits, and transceiver circuits.

8. A method of enabling a circuit feature on an integrated circuit device using a server, the method comprising:
receiving a license file and a public key of the integrated circuit device at the server, wherein the license file identifies the circuit feature to be enabled;
determining whether the identified circuit feature is capable of being enabled on the integrated circuit device;
generating an encrypted message and a signed digital signature;
in response to determining that the circuit feature is capable of being enabled, including instructions to enable the identified circuit feature on the integrated circuit device in the encrypted message; and
transmitting the encrypted message and the signed digital signature to the integrated circuit device.

9. The method as defined in claim 8, further comprising:
obtaining a private key that corresponds to the public key of the integrated circuit device.

10. The method as defined in claim 9, wherein generating the encrypted message comprises generating the encrypted message using the private key.

11. The method as defined in claim 8, wherein determining whether the identified circuit feature is capable of being enabled on the integrated circuit device comprises:
determining whether a user has paid for the circuit feature identified in the license file.

12. The method as defined in claim 11, further comprising:
in response to determining that the user has not paid for the identified circuit feature, including instructions to prevent the integrated circuit device from enabling the identified circuit feature in the encrypted message.

13. The method defined in claim 8, wherein determining whether the identified circuit feature is capable of being enabled on the integrated circuit device comprises:
determining a license limit for the identified circuit feature of the integrated circuit device.

14. The method defined in claim 13, wherein determining whether the identified circuit feature is capable of being enabled on the integrated circuit device further comprises:
in response to determining that the license limit for the circuit feature has been exceeded, including instructions to prevent the integrated circuit device from enabling the identified circuit feature in the encrypted message.

15. An integrated circuit device, comprising:
a first circuit feature formed within the integrated circuit device and enabled for a user's use; and
a second circuit feature formed within the integrated circuit device and only available to the user when the second circuit feature is enabled by an enabling message that is received from external source, wherein the integrated circuit device decrypts and authenticates the enabling message prior to enabling the second circuit feature.

16. The integrated circuit device as defined in claim 15, further comprising:
a data decryption block that identifies the enabling message by decrypting an encrypted message received from the external source using a public key.

17. The integrated circuit device as defined in claim 16, further comprising:
a message authenticator block that is coupled to the data decryption block, wherein the message authenticator block authenticates the enabling message using a signed digital signal received from the external source.

18. The integrated circuit device as defined in claim 15, wherein the first circuit feature comprises a circuit feature selected from the group of circuit features consisting of: a phase-locked loop (PLL) circuit, a memory circuit, and a transceiver circuit.

19. The integrated circuit device as defined in claim 15, wherein the second circuit feature comprises a circuit feature selected from the group of circuit features consisting of: a phase-locked loop (PLL) circuit, a memory circuit, and a transceiver circuit.

20. The integrated circuit device as defined in claim 15, further comprising:
an input/output (I/O) block that receives the enabling message and a signed digital signal.
